(19) United States
(12) Patent Application Publication
(10) Pub. No.: US 2026/0336678 A1
(43) Pub. Date: Oct. 29, 2026

(54) DRIVE MODULE FOR A VEHICLE

(71) Applicant: THE SMART FAMILY UG HAFTUNGSBESCHRÄNKT, Frankfurt (DE)

(72) Inventor: Daniel C. KUCZAJ, Frankfurt (DE)

(21) Appl. No.: 18/997,281

(22) PCT Filed: Jul. 21, 2023
(86) PCT No.: PCT/DE2023/100539

§ 371 Date: Jan. 21, 2025

(30) Foreign Application Priority Data
Jul. 22, 2022 (DE) 10 2022 118 458.7

(51) Int. Cl. B62B 5/00; A61G 5/04; B62B 9/28

(52) U.S. Cl. CPC B62B 5/005; A61G 5/047; B62B 5/0076; B62B 9/28

(57) ABSTRACT

The present invention relates to a drive module with a seating or standing platform for connection to a vehicle, wherein the drive module is detachably connected to the vehicle and can be moved between a driving position and a resting position along a suspension, with the drive module located underneath the vehicle in the resting position and underneath, partially behind, or entirely behind the vehicle in the driving position, as well as to a method and use of such a drive module.

The present invention relates to a drive module for a vehicle.

In the state of the art, there are various vehicles known that either lack their own drive or are optionally delivered with or without a drive.

Additionally, there are vehicles designed to transport persons, persons along with goods, or solely goods.

An example of a vehicle with an optional drive module is a wheelchair. Most wheelchairs are delivered in a purely mechanical form, though there are also electric wheelchairs equipped with an integrated motor. A third option is external drive modules for wheelchairs, which are also mounted on wheels and can be held by the user or detachably connected to the wheelchair. In these cases, the wheelchair, along with the user, is usually pulled, and the drive module is positioned in front of the wheelchair.

Another vehicle type known from the state of the art is a stroller. These are generally delivered in a purely mechanical form and pushed by the child's companions. However, a few models are known to feature an integrated motor, though these are developed solely as display pieces or experimental models and are not used in practice.

Known for strollers are transport modules for older children, often referred to as buggy boards, which can be attached to the stroller and travel on their own wheels. Older siblings can stand on a buggy board or, in certain designs, sit, and are pushed along by the child's companions.

Of course, a variety of other vehicles are known from the state of the art for the transportation of persons and/or goods, which can be equipped with or without a drive or a connectable drive module.

However, a drawback of all known designs is that there are no connectable drive modules for vehicles without a drive that also allow for transporting persons on these modules.

This is particularly disadvantageous because, for instance, a companion of a wheelchair user cannot ride along. The same applies to a drive module for a stroller or drive modules for vehicles intended for the transportation of goods. For transporting goods over long distances, a connectable drive module with the capability to transport persons would also be advantageous.

The objective of the present invention, against this background, is to provide a connectable drive module for a vehicle that not only powers the vehicle itself but also allows individuals to stand or sit on it.

This objective is achieved through a drive module with a standing or seating surface for connection to a vehicle, wherein the drive module is detachably connected to the vehicle and can be moved along a suspension between a driving position and a resting position. In the resting position, the drive module is located under a reclining, seating, or standing surface of the vehicle, while in the driving position, it is located under, partially behind, or behind the reclining, seating, or standing surface of the vehicle.

The invention is based on the surprising insight that a drive module with an integrated standing or seating surface can be connected to a vehicle, enabling it to be powered by the drive module.

It has proven particularly advantageous for the drive module to be moved into a resting position beneath the vehicle's reclining, seating, or standing surface, so that it does not obstruct the user.

By positioning the drive module under the vehicle's reclining, seating, or standing surface, it becomes virtually invisible and does not detract from the stroller's aesthetics. Furthermore, handling remains unaffected, as the drive module does not interfere with the vehicle's movement.

The drive module can be in either a driving or resting position under the vehicle. In the resting position, the drive module does not exert any active force on the wheels of the module.

Thus, it is possible according to the invention for a non-powered vehicle to be coupled with an active drive module, wherein a seat or standing platform can be extended or retracted as needed.

The invention advantageously comprises various drive modes. A rest mode, in which the drive module is in a resting position and does not provide any additional driving force. A support mode, in which the drive module, using sensors in the wheels, detects the direction in which the user is moving the vehicle and supports the movement with an adjustable driving force. And a driving mode, in which the user operates the vehicle without exerting their own force, including through the drive module, and selects speed and direction via a control module.

It has proven particularly advantageous that the drive module, in the resting position, is raised and located under the vehicle, while in the driving position, it is lowered and located under, partially behind, or entirely behind the vehicle.

Raising the drive module ensures that it imposes little to no restriction on the mobility of the coupled vehicle. In particular, it can be advantageous if, in the raised resting position, the wheels of the drive module no longer touch the ground, allowing the vehicle to be moved without any limitations imposed by the drive module.

For a drive module according to the invention, it may be advantageous if the drive module itself comprises at least one accumulator and a drive wheel that is operatively connected to an electric motor, wherein the electric motor is electrically connected to the accumulator, and the drive wheel is in contact with the ground in the driving position.

The use of electric motors and accumulators for driving vehicles is fundamentally known to those skilled in the art from the state of the art and requires no further specification. Depending on the type of vehicle, the skilled person will select a suitable combination of electric motor and accumulator.

According to a preferred embodiment, it is provided that, in a standing or sitting position, the standing or sitting platform of the drive module is located partially behind or entirely behind the vehicle.

It has proven particularly advantageous if the standing or sitting platform can be shifted, based on the user's preferences, from underneath the vehicle to behind the coupled vehicle.

This can, for example, allow for the transportation of one person or two or more people.

Furthermore, vehicles are often equipped with handles for pushing. When the drive module according to the invention is used for drive assistance or as the sole drive mechanism, it is advantageous if the drive module is only moved to the extent that good operability of the handles remains possible.

For example, the angle and distance of the handles for pushing vehicles vary individually, so that by appropriately positioning the drive module, optimal operability of the vehicle can always be ensured.

In particular, it may be provided that the suspension of the drive module is connected to a rear axle of the vehicle, a housing of the rear axle, a suspension of the rear axle, and/or a frame element of the vehicle.

As well, standing or sitting positions can also be provided for one, two, or more people.

In principle, various connections between the drive module and the vehicle are conceivable and possible. However, it has proven particularly advantageous, especially for certain vehicles, such as strollers, to connect the drive module directly to the rear axle or to frame elements adjacent to the rear axle.

In particular, it may be provided that the suspension is detachably connected to the vehicle, specifically at a position centered above or on the rear axle, on side struts in the area of the rear axle, and/or at two points on the rear axle.

Furthermore, it may be preferred that the drive module, in the resting position, is connected to the vehicle via a fastening element so that the drive module is raised, and in particular, the drive wheel or wheels do not touch the ground.

As previously explained, a raised drive module allows the vehicle to move as if no drive module were coupled. Since the drive module is located under the vehicle in the resting position and is particularly raised, the user does not notice it.

It may be particularly advantageous if the fastening element is a magnet, a snap-in system, a hook-in system, a Velcro fastener, a bayonet lock, a press-stud system, and/or a clamping system.

Various fastening elements are advantageous for fixing the drive module in the raised position. A particularly advantageous fastening element is a magnet, which reliably enables both the connection and disconnection of the drive module and vehicle for fixing in the raised position.

Depending on the design of the drive module and the type of vehicle, fastening elements in the form of Velcro fasteners or clamping systems may also be practical, or for particularly secure fastening, hook-in systems or bayonet locks may be suitable.

It may particularly be provided that the fastening element is arranged at the front end of the drive module and/or at or near the front end of the vehicle, preferably above a front axle of the vehicle and/or on the vehicle frame.

It has proven technically advantageous for the fastening element to be positioned at the front end of the drive module and/or at or near the front end of the vehicle, as the drive module in the resting position is located under the coupled vehicle.

Consequently, positioning the fastening element at the front end of the drive module and/or at the front end of the vehicle allows the drive module to form a standing or sitting platform approximately the length of the vehicle.

Particularly when the drive module is coupled to the rear axle or near the rear axle of the vehicle, the drive module can be fully retracted and extended along a vertical line relative to the rear axle, utilizing a significant adjustment range.

According to one embodiment, it may be preferred that at least one guide rail is included, along which the drive module can be moved from the sitting or standing position into the resting position and back.

It may further be preferred that the lowering and raising of the drive module under, partially behind, or entirely behind the vehicle into the driving position is achieved using a spring element, a magnet, compressed air, gravity, and/or an electric motor.

It has proven particularly advantageous for the drive module to be fastened to the vehicle at or near the rear axle. The inventive rail system with guide rails has proven effective for moving the drive module relative to the vehicle.

According to a particularly advantageous embodiment of the present invention, a control module is included, designed and configured to control the speed and driving direction of the drive wheel, adjust the drive module between the driving position and the resting position, and/or select and activate/deactivate control programs.

It may be provided that the control module can be flexibly positioned via a wireless transmission module and includes an accumulator to power its components.

Such a control module can, in particular, be arranged on a handlebar of a vehicle. The control module may feature mechanical buttons and switches and/or digital control options.

A coupling with mobile phones can also be provided, which is configured via wireless communication, for example, through Bluetooth or WLAN.

According to one embodiment of the present invention, it can be provided that a first brake is included, which is actuated by the control module, and/or a second brake that can be mechanically activated on the drive module.

It has proven advantageous to include a mechanical brake, which is designed, for example, in the form of a foot brake. This brake can be used exclusively, alternatively, or in combination with an electric brake or a brake controllable via the control module.

The inventive foot brake can be arranged on one side or both sides, particularly at the lateral ends of the drive device, and can be moved downward by applying pressure so that it rests on the drive wheels and acts on them to brake.

The invention also provides a method for operating a drive module according to one of the preceding claims, comprising the following steps, particularly in this order:
a) Connecting the drive module to a vehicle.
b) Controlling the drive module to set a speed and driving direction of the drive wheel, select the position of the drive module between the driving position and the resting position, and/or select a control program, particularly to select and parameterize a driving or support mode.

It can be provided that the control program includes a sleep mode in which the drive module moves the vehicle forward and backward over a defined distance at regular, adjustable intervals.

Such a sleep mode has the particular advantage that, for example, a drive module coupled to a stroller can move the stroller forward and backward within a defined area, so that a child falls asleep without the accompanying persons having to actively move the stroller.

Finally, the invention provides for the use of an inventive drive module in connection with a stroller.

The inventive drive module is thus based on the surprising realization that it is possible to provide a drive for a vehicle on which one or more people can sit or stand simultaneously, without the drive module itself being obtrusive.

Thanks to the inventive resting position, it is possible to use the coupled vehicle without the user experiencing any disadvantages due to the coupling with the drive module. Instead, the drive module is essentially “invisible,” stowed under the vehicle.

With the inventive optional control module, which interacts with the drive module either via a wired or wireless connection, the user can select various modes and control the drive module. This includes, on the one hand, driving and braking—i.e., selecting different driving speeds and directions—and, on the other hand, adjusting the seating or standing platform of the drive module relative to the coupled vehicle.

Such adjustments are particularly advantageous for various reasons. As described, the drive module is fully positioned underneath the vehicle in the resting position, allowing the vehicle to be handled as if no drive module were present.

The seating or standing platform can especially be adjusted to fit the geometry of the vehicle while still enabling the transport of persons. It can also be configured to accommodate one or potentially several persons on the platform. The drive module thus offers maximum flexibility.

Finally, it is particularly advantageous that the drive module can optionally be raised in the resting position, so that the drive wheels do not touch the ground.

An inventive drive module can advantageously be coupled with strollers, wheelchairs, and other vehicles such as workshop carts.

Various program modes are conceivable, such as the mentioned sleep mode, providing not only propulsion but also additional functionalities.

Specifically, the control module allows the selection between four different modes. In one mode, the drive module is in a resting position and does not actively assist in moving the vehicle. In a second mode, the drive module assists in movement by applying additional force when it detects movement of the vehicle by the user and exerts force in the direction the user is moving the vehicle. In a third mode, the drive module can independently move the vehicle, with the user selecting the speed and direction. The fourth mode is the described sleep mode for strollers, where the drive module moves the stroller forward and backward.

For the user's safety, and particularly in the case of strollers and wheelchairs, a mechanical brake, preferably a foot brake, is also provided. This brake can be operated independently of the control module and can fully lock the wheels of the drive module.

Additional advantages of an inventive drive module are described below with reference to exemplary embodiments of the invention. The following figures illustrate:

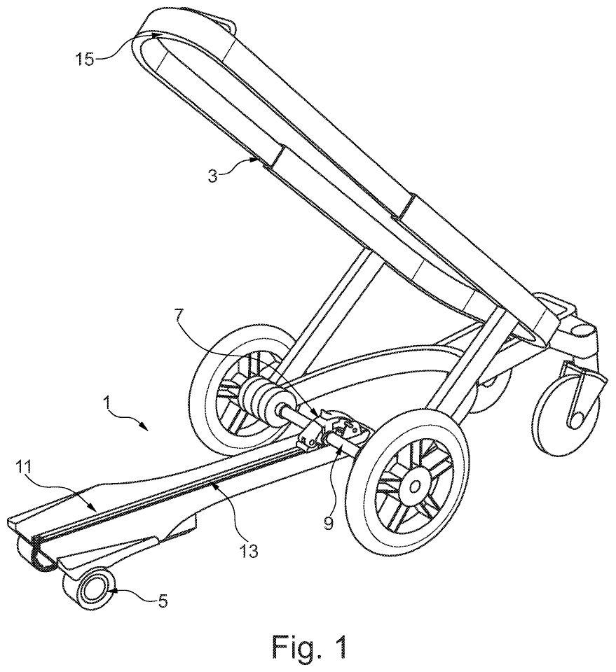

FIG. 1: A perspective view of an inventive drive module in connection with a stroller;

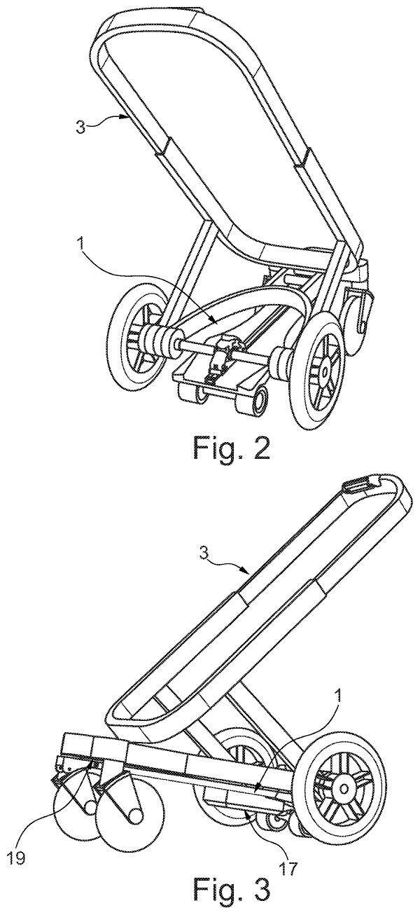

FIG. 2: The drive module from FIG. 1 in a resting position, shown in a perspective view;

FIG. 3: Another view of the drive module from FIGS. 1 and 2 in the resting position;

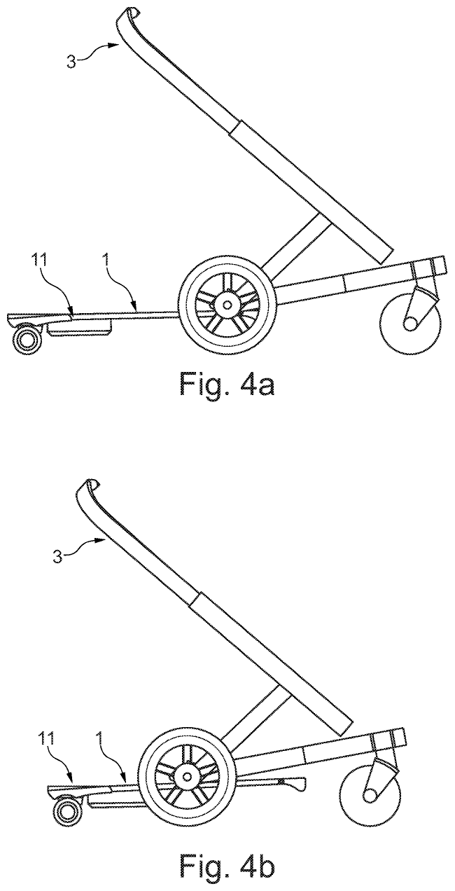

FIGS. 4a and 4b: Schematic side views of the adjustable standing positions of an inventive drive module according to the shown embodiment;

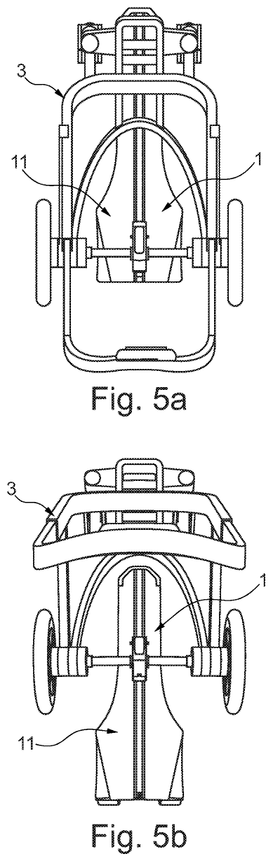

FIGS. 5a and 5b: A top view of an adjusted standing platform of an inventive drive module underneath a stroller;

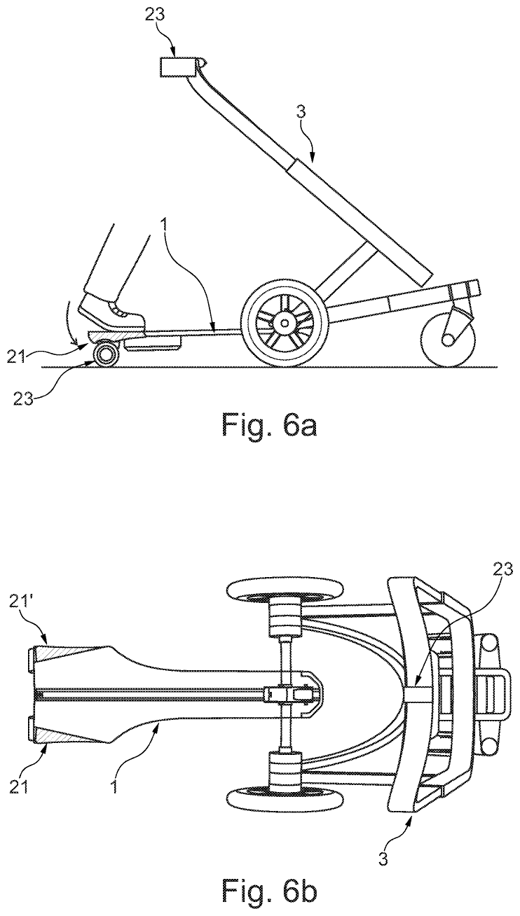

FIGS. 6a and 6b: A top and side view of an embodiment of a mechanical brake for a drive module.

FIG. 1 shows an inventive drive module (1) in an exemplary embodiment, which is connected to a stroller (3). The drive module (1) shown in FIG. 1 is in the driving position, where it is extended backward relative to the stroller (3) under the vehicle—here, under the stroller (3).

The drive module (1) includes drive wheels (5) that are operatively connected to an electric motor (not shown in FIG. 1). The drive module (1) is attached via its suspension (7) to the rear axle (9) of the stroller (3).

In the extended driving position of the drive module (1), a standing platform (11) is provided on which a person (not shown) can stand. The drive module (1) with the standing platform (11) can be moved along a rail (13) so that the user can adjust their desired standing position relative to the handle (15) of the stroller (3).

The drive module (1) can also be moved entirely underneath the lying, sitting, or standing platform of the stroller (3) along the rail (13). This is shown in FIGS. 2 and 3.

As clearly visible in FIGS. 2 and 3, a drive module (1) according to the exemplary embodiment shown can be completely positioned underneath the lying, sitting, or standing platform of the stroller (3).

For this purpose, the standing platform (11) is moved along the rail (13). To raise the drive module (1), the movement along the rail (13) occurs at an upward angle, with the drive module (1) being additionally secured to the underside of the stroller (3) using a fastening element, here in the form of a magnet (19).

In the perspective view of FIG. 3, a sealed accumulator and the electronics optionally housed in the casing (17) of the drive module (1) are clearly visible.

FIGS. 4a and 4b show how the standing platform (11) of the drive module (1) can be adjusted relative to the stroller (3) as desired. For example, in the position of the standing platform (11) shown in FIG. 4a, an adult and a child can stand together on the platform (11). In the partially extended position shown in FIG. 4b, a child can stand on the platform (11) while an adult pushes the stroller.

FIGS. 5a and 5b show a top view of an adjusted standing platform (11) of an inventive drive module (1) under the stroller (3) and partially extended.

FIGS. 6a and 6b show the inventive mechanical brake (21, 21′) that can optionally be included in preferred embodiments of the drive module (1).

The brake (21, 21′) can be operated by the user's foot by pressing a brake element downward, which then rests on the wheel (23) of the drive module (1).

Additionally, FIGS. 6a and 6b show the inventive control module (23), which is arranged on the handle of the stroller (3) and allows for the selection of the inventive driving modes as well as the adjustment of the standing platform.

The variants described in the exemplary embodiments are preferred embodiments of the invention and are not to be understood as limiting.

1. Drive module with a seating or standing platform for connection to a vehicle, wherein the drive module is detachably connected to the vehicle and can be moved between a driving position and a resting position along a suspension, wherein in the resting position, the drive module is located underneath a lying, sitting, or standing platform of the vehicle, and in the driving position, it is located underneath, partially behind, or behind the lying, sitting, or standing platform of the vehicle.

2. Drive module according to claim 1, characterized in that the drive module in the resting position is located underneath the lying, sitting, or standing platform of the vehicle and is raised, and in the driving position is located underneath, partially behind, or behind the lying, sitting, or standing platform of the vehicle and is lowered.

3. Drive module according to claim 1, characterized in that the drive module comprises at least one accumulator and a drive wheel operatively connected to an electric motor, wherein the electric motor is electrically connected to the accumulator, and wherein the drive wheel is in contact with the ground in the driving position.

4. Drive module according to claim 1, characterized in that in a standing or seating position, the standing or seating platform of the drive module is located partially behind or completely behind the standing or seating platform of the vehicle.

5. Drive module according to claim 1, characterized in that the suspension is connected to a rear axle of the vehicle or to a casing of the rear axle, a suspension of the rear axle, and/or a frame element of the vehicle.

6. Drive module according to claim 5, characterized in that the suspension is detachably connected to the vehicle, particularly at a position centered above or on the rear axle, on side struts near the rear axle, and/or at two points on the rear axle.

7. Drive module according to claim 1, characterized in that in the resting position, the drive module is connected to the vehicle via a fastening element so that the drive module is raised, and particularly the drive wheel or wheels do not touch the ground.

8. Drive module according to claim 7, characterized in that the fastening element is a magnet, a snap-in system, a hook-in system, a Velcro fastener, a bayonet lock, a press-stud system, and/or a clamping system.

9. Drive module according to claim 7, characterized in that the fastening element is arranged at the front end of the drive module and/or on or near the front end of the vehicle, preferably above a front axle of the vehicle and/or on the vehicle frame.

10. Drive module according to claim 1, characterized in that at least one guide rail is included along which the drive module can be moved from the seating or standing position into the resting position and back.

11. Drive module according to claim 1, characterized in that lowering and raising the drive module underneath, partially behind, or behind the lying, sitting, or standing platform of the vehicle into the driving position is achieved using a spring element, a magnet, compressed air, gravity, and/or an electric motor.

12. Drive module according to claim 1, characterized in that a control module is included, designed and configured to control the speed and driving direction of the drive wheel, adjust the position of the drive module between the driving position and the resting position, and/or select and activate/deactivate control programs.

13. Drive module according to claim 12, characterized in that the control module can be flexibly positioned via a wireless transmission module and includes an accumulator to power its components.

14. Drive module according to claim 1, characterized in that it comprises a first brake controlled by the control module and/or a second brake that can be mechanically activated on the drive module.

15. Method for operating a drive module according to claim 1, comprising the following steps, particularly in this order:
a) Connecting the drive module to a vehicle;
b) Controlling the drive module to set a speed and driving direction of the drive wheel, select the position of the drive module between the driving position and the resting position, and/or select a control program, particularly to select and parameterize a driving or support mode.

16. Method according to claim 15, characterized in that the control program includes a sleep mode in which the drive module moves the vehicle forward and backward over a defined distance at regular, adjustable intervals.

17. (canceled)
